(19) United States
(12) Patent Application Publication
(10) Pub. No.: US 2016/0363028 A1
(43) Pub. Date: Dec. 15, 2016

(54) HEATER FOR A UREA TANK

(71) Applicants: Pierre DE KEYZER, Brussels (BE); Kevin SLUSSER, Ixelles (BE)

(72) Inventors: Pierre DE KEYZER, Brussels (BE); Kevin SLUSSER, Ixelles (BE)

(73) Assignee: PLASTIC OMNIUM ADVANCED INNOVATION AND RESEARCH, Brussels (BE)

(21) Appl. No.: 15/115,071

(22) PCT Filed: Jan. 28, 2015
(86) PCT No.: PCT/EP2015/051741

§ 371 Date: Jul. 28, 2016

(30) Foreign Application Priority Data
Jan. 29, 2014 (EP) 14153088.1

(51) Int. Cl. F01N 3/28; H01C 17/02; H05B 3/82

(52) U.S. Cl. CPC F01N 3/2896; H05B 3/82; H01C 17/02

(57) ABSTRACT

A heater for a plastic tank for storing urea. The heater includes a part and an electrical heating element. The part is fixed to the electrical heating element. The electrical heating element is surrounded by a plastic sheath. The part further includes a plastic material which is fusion bonded to the plastic sheath. The plastic material of the part is overmolded on the plastic sheath.

### FIELD OF INVENTION

The field of the invention relates to a heater for a plastic tank for storing urea, a method for manufacturing such a heater, and a urea tank comprising such a heater.

### BACKGROUND

Legislation on vehicle and heavy goods vehicle emissions stipulates, amongst other things, a reduction in the release of nitrogen oxides NOx into the atmosphere. One known way to achieve this objective is to use the SCR (Selective Catalytic Reduction) process which enables the reduction of nitrogen oxides by injection of a reducing agent, generally ammonia, into the exhaust line. This ammonia may derive from the pyrolytic decomposition of an ammonia precursor solution, whose concentration may be the eutectic concentration. Such an ammonia precursor is generally a urea solution.

With the SCR process, the high levels of NOx produced in the engine during combustion at optimized efficiency are treated in a catalyst after exiting the engine. This treatment requires the use of the reducing agent at a precise concentration and of extreme quality. The solution is thus accurately metered and injected into the exhaust gas stream where it is hydrolysed before converting the nitrogen oxide (NOx) to nitrogen (N2) and water (H2O).

In order to do this, it is necessary to equip the vehicles with a tank containing an additive solution (generally an aqueous urea solution) and also a device for metering the desired amount of additive and injecting it into the exhaust line.

Given that the aqueous urea solution generally used for this purpose (eutectic 32.5 wt % urea solution) freezes at −11° C., it is necessary to provide an internal heater to liquefy the solution in order to be able to inject it into the exhaust line in the event of starting in freezing conditions.

Several heaters have been provided in the prior art for this purpose. Generally, these heaters comprise an electrical heating element surrounded by a plastic sheath. Generally, these heaters are mounted through a through-hole in the tank wall. When a heater has to be mounted through a through-hole in a leak tight way, according to prior art solutions, use is made of an O-ring or a glue which is arranged between the wall of the though-hole and the heater.

FIG. 1 illustrates a background solution for mounting a heater through an opening O of a wall part of a urea tank P. In the example of FIG. 1, the heater comprises three electrical cables (i.e. electrical heating element). A connecting part 1 e.g. made of a polyamide material is provided with three through-holes 11, 12, 13 for three electrical cables 21, 22, 23. Each electrical cable 21, 22, 23 is provided with an O-ring 31, 32, 33 for leak tight mounting in the connecting part. The connecting part is provided with a further O-ring 2 for leak tight mounting of the connecting part 1 in the opening O.

A disadvantage of this solution is that O-rings tend to lose their good compression properties after aging. Consequently, the sealing is not ensured in the long term due to durability issues. Further, plastic parts tend to show creep if a constant stress is applied thereon. As a result, the O-ring will not be properly maintained in cases of constant stress.

Other solutions use a glue or mastic instead of an O-ring. Also such solutions do not ensure a good durability of the seal. Moreover, there is a risk that the glue contaminates the content of the tank.

### SUMMARY

The object of embodiments of the invention is to ensure a sealed interface between a heater and a part in an improved manner.

According to a first aspect of the invention there is provided a heater for a plastic tank for storing urea. The heater comprises a part and an electrical heating element. The part is fixed to the electrical heating element. The electrical heating element is surrounded by a plastic sheath. The part further comprises a plastic material which is overmoulded on the plastic sheath. The plastic material of the part is such that it is fusion bonded to the plastic sheath.

Thus, it is proposed an arrangement where the plastic material of the part is fusion bonded to the plastic sheath. In that way a very robust and leak-tight seal may be obtained. In other words neither O-ring, nor glue is needed between the sheath and the part.

In a first particular embodiment, the electrical heating element is a resistive wire.

In a second particular embodiment, the electrical heating element comprises an electrically resistive fabric and at least one conductive track or wire affixed to the fabric. Advantageously, the fabric comprises a polyurethane coating containing carbon particles. In a preferred embodiment, the electrical heating element is sandwiched between two plastic protective films, the plastic protective films forming the plastic sheath.

Thus, the heater according to this second particular embodiment is a multilayer flexible heater. The qualifier “flexible” is in fact understood to mean “easily deformable”, this generally being in a reversible manner. The resistive track(s) or wire(s) may be based on metal, carbon, etc. or even a combination of such conductive materials. They are generally metallic (and most particularly preferably, made of a urea-resistant metal such as a stainless steel).

In an alternative embodiment the electrical heating element is an optical wire, and the heating comprises applying optical signals through said optical wire.

According to an advantageous aspect of the invention, the electrical heating element and the plastic sheath are sized such that when a predetermined level of current passes through the electrical heating element, the plastic sheath is brought to a temperature slightly below or above the molten state so as to be fusion bonded to the plastic material of the part during overmoulding. In that way a good bond between the plastic material of the part and the plastic sheath is obtained.

Preferably, the electrical resistance of the electrical heating element is larger than 0.01 Ohm/m (at 20° C.), more preferably larger than 0.1 Ohm/m (at 20° C.). Thus, the electrical resistance of the electrical heating element is preferably relatively high in order to be capable of generating heat in the tank, and this electrical property can be used advantageously in embodiments of the invention to bond the plastic sheath to the plastic material of the part.

Preferably the plastic sheath is made of a polymer material that is compatible with the plastic material of the part in the sense that polymer entanglements and intermolecular diffusion can be created at the interface of the sheath and the plastic material of the part. Preferably the plastic material of the part is a thermoplastic material, and the sheath is made of a thermoplastic material.

In a possible embodiment the sheath is made of polyamide material, e.g. PA66, and the plastic material is also made of a polyamide material. Optionally, the plastic material could be a polyethylene or polypropylene comprising an additive (for example, PRIEX (registered trademark) or Admer GT6) to ensure its compatibility with the material of the sheath.

According to another aspect of the invention there is provided a urea tank comprising a heater of any one of the embodiments above, wherein the part is a wall part of the tank or is mounted in a wall of the tank, or is the tank itself.

In a particular embodiment, the part can be a wall part of the tank. In this particular embodiment, a portion of the tank body is directly formed around the heater such that the plastic material of the portion of the tank body is bonded to the plastic sheath of the heater.

In another particular embodiment, the part can be a connecting part (i.e. connector) configured to be mounted in a wall of the tank.

The urea tank according to the invention is preferably made of plastic, that is to say made of a material comprising at least one synthetic resin polymer. In a preferred embodiment the tank is made of polyamide, e.g. polyamide-6. However, all types of plastic may be suitable. Particularly suitable are plastics that belong to the category of thermoplastics. The term “thermoplastic” is understood to mean any thermoplastic polymer, including thermoplastic elastomers, and blends thereof. The term “polymer” is understood to mean both homopolymers and copolymers (especially binary or ternary copolymers).

According to yet another aspect of the invention there is provided a method for manufacturing a heater of any one of the embodiments above, comprising the steps of:

selecting an electrical heating element, said electrical heating element being surrounded by a plastic sheath;
fixing a part to the electrical heating element, said part being made of a plastic material,

The step of fixing the part comprises:

fusion bonding the plastic material of the part to the plastic sheath and overmoulding the plastic material of the part on the plastic sheath.

In a preferred embodiment, the step of fusion bonding comprises applying a predetermined level of current through the electrical heating element so as to heat the electrical heating element and bring the plastic sheath to a temperature slightly below or above the molten state.

The heating is such that the plastic sheath is brought to a temperature slightly below or above the molten state. During the step of overmoulding, the plastic material of the part is in a molten state and is applied onto the plastic sheath brought in the molten state. By applying a sufficient level of current through the electrical heating element, sufficient heat may be generated at the interface between the sheath of the heater and the plastic material of the part, for the sheath to bond to the plastic material of the part. In that way a very robust and leak-tight seal may be obtained. In other words neither O-ring, nor glue is needed between the sheath and the part.

According to an embodiment the heating of the electrical heating element comprises causing heat to be generated in said electrical heating element. In a preferred embodiment the electrical heating element is a wire having an electrical resistance; and the heating comprises applying an electric current through the electrical heating element. In other words the resistive property of the wire may be used to cause heat to be generated in the heater in order to increase the temperature of its sheath. This is a very convenient way for causing sufficient heat to be generated in the heater, and this technique can easily be applied regardless of the technique used for overmoulding the plastic part. The applied current may comprises a DC component and/or an AC component.

According to a variant the heating comprises applying heat on said electrical heating element. According to an exemplary embodiment the heater may be placed in an oven to heat it, whereupon the plastic material may be applied, e.g. by placing the heated heater in a mould and injecting the plastic material in the mould. Applying heat at one end or at both ends of the electrical heating element is another option, e.g. by connecting said electrical heating element to a high temperature source.

Preferably the plastic material of the part is overmoulded on the sheath of the heater. More preferably, the plastic material surrounds the heater over a length which is smaller than the length of the heater.

The step of overmoulding can be performed by using an injection molding or injection compression molding process. In an exemplary embodiment the overmoulding comprises: placing the heater between a first mould part comprising a first cavity and a second mould part comprising a second cavity, wherein the first and second cavity are designed for delimiting a volume which surrounds a portion of the heater; and injecting the plastic material around the heater whilst heating the electrical heating element or shortly after having heated the electrical heating element. The skilled person understands that more than two mould parts may be used and/or that more than one heater may be overmoulded depending on the application of the part that is being manufactured. Preferably the heating is performed by connecting the electrical heating element to an electrical power source outside of the mould formed by said first and second mould parts. Alternatively the heating may be performed by actively applying heat to the electrical heating element from outside the mould formed by said first and second mould parts. Optionally the first and/or the second mould part may be provided with a channel for receiving the heater, in which case the heater is placed in the channel.

Alternatively, the step of overmoulding can be performed by using a “hot pressing” process. This process is based on the use of plastic granules that are introduced inside a mould. For example, once the heater is introduced inside the mould, the heater is heated and the plastic granules are heated so as to be in a molten state, and to bond with the heated heater (i.e. sheath part). The “hot pressing” process is well known and thus it is not further described in detail in this document.

In a preferred embodiment the heating of the electrical heating element is such that said plastic sheath bonds to the plastic material of the part, by fusing together the plastic sheath and the plastic material of the part through the heat applied on/generated in the electrical heating element.

In a preferred embodiment the material of the plastic sheath is bonded to the plastic material of the part, wherein an interface between the sheath and the plastic material of the part comprises polymer entanglements and intermolecular diffusion between the material of the sheath and the plastic material of the part.

In a possible embodiment the sheath is made of a polyamide material or a poly-ethylene material; and/or the plastic material is a poly-ethylene material optionally comprising an additive for improving the compatibility, a polyamide material or a polypropylene material.

### BRIEF DESCRIPTION OF THE FIGURES

The accompanying drawings are used to illustrate presently preferred non-limiting exemplary embodiments of devices of the present invention. The above and other advantages of the features and objects of the invention will become more apparent and the invention will be better understood from the following detailed description when read in conjunction with the accompanying drawings, in which:

FIG. 1 illustrates schematically a prior art embodiment;

FIGS. 2A, 2B and 2C illustrate schematically a first embodiment of the method of the invention and show a top view of a bottom mould part on which a cable is placed, a side view with the mould open and a side view with the mould closed, respectively;

FIG. 3 is a schematic view of a part fixed to a cable according to a first embodiment of the invention;

FIG. 4 a schematic view of a part fixed to a cable according to a second embodiment of the invention;

FIG. 5 illustrates schematically a second embodiment of the method of the invention; and

FIGS. 6A, 6B and 6C illustrate schematically three variants of cables suitable for use in a method of the invention;

FIG. 7 a schematic view of two parts fixed to a cable according to a third embodiment of the invention; and

FIGS. 8A, 8B, 8C and 8D illustrate another particular embodiment of a heater according to the present invention.

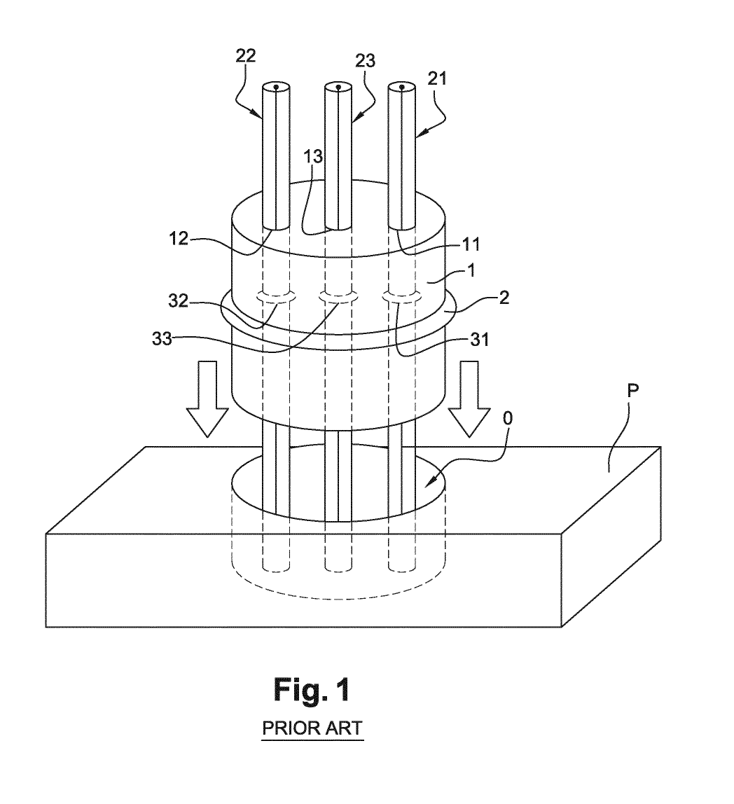

### DESCRIPTION OF EMBODIMENTS

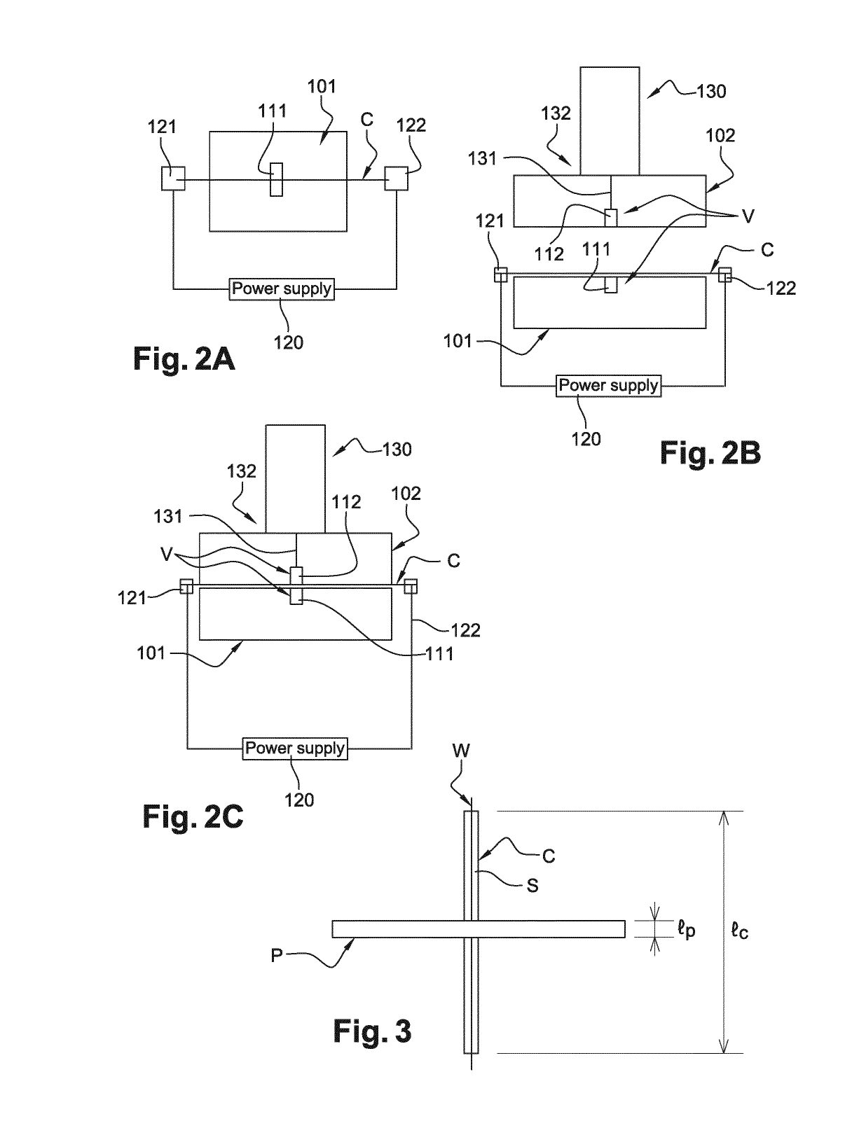

FIGS. 2A-2C illustrate a first embodiment of a heater according to the present invention. In this exemplary embodiment the heater is a cable C. A plastic part P is fixed to the cable C. Although not illustrated in FIGS. 2A-2C, the cable comprises a wire (i.e. electrical heating element) surrounded by a plastic sheath. In the illustrated embodiment the wire is an electrical wire having an electrical resistance, and the wire is heated by sending an electric current, typically a DC current, through the wire and a heated plastic material is applied around the wire by overmoulding.

The overmoulding process is performed as follows using a two-part mould 101, 102. In a first step the cable C is placed on a bottom mould part 101 comprising a bottom cavity 111, see the top view of FIG. 2A and the side view of FIG. 2B. In a second step a top mould part 102 comprising a top cavity 112 is brought in contact with the bottom mould part 101, see the side view of FIG. 2C. The top and bottom cavities 111, 112 are designed for delimiting a volume which surrounds the cable C. In a third step a heated plastic material is injected via an injection moulding machine 130, an injection nozzle 132, and an injection channel 131 in the top mould part 102. Simultaneously the wire of the cable C is heated by connecting said wire via connectors 121, 122 to an electrical power source 120 outside of the mould 101, 102. Optionally the bottom and/or top mould 101, 102 are provided with a channel (not-illustrated) for tightly receiving the cable C.

The heating of the wire is such that the plastic sheath of the cable C bonds to the plastic material through fusing. If the sheath is made from a polyamide 6 material the current sent through the wire is such that the temperature of the wire is higher than the melting temperature of the polyamide 6 material, e.g. a temperature of more than 230 degrees Celsius. Typically, the wire is a metal wire having an electrical resistance which is larger than 0.01 Ohm/m (at 20° C.), e.g. between 0.10 and 10 Ohm/m (at 20° C.). The current may have a DC component and/or an AC component.

The plastic material is injected in the mould in a molten state, but the temperature of the injected plastic material will quickly decrease as the material spreads in the volume V formed by the cavities 111, 112. If the wire would not be heated, the temperature of the molten plastic material, when reaching the sheath of the cable C, would be too low for causing a good fusing of the sheath material and the injected plastic material. However, by sending a current though the wire, sufficient heat is generated at the interface between the sheath and the injected material, such that a good bond is achieved.

The plastic sheath is made of a thermoplastic polymer material that is compatible with the injected thermoplastic material in the sense that polymer entanglements are created at the interface of the sheath and the plastic material. The sheath may be made e.g. of a polyamide material, and the injected plastic material may be e.g. a compatible poly-ethylene material optionally comprising an additive for improving the compatibility (e.g. PE grafted with maleic anhydride, PRIEX®), a polyamide material or a compatible polypropylene material. A polyethylene, grafted with an extra high content of maleic anhydride has the advantage that the grafted maleic anhydride introduces polarity to the polymer achieving compatibility between polyolefins and more polar materials or polymers like EVOH or Polyamide. More generally, the skilled person understands that many compatible materials exist for the sheath and the plastic part that is to be formed. There exist tables showing plastic welding compatibility (see e.g. www.lpkfusa.com/lq or http://www.lpkfusa.com/lq/articles.htm) from the laser welding company LPKF). Such welding compatibility tables also provide a good indication of the compatibility of two materials (sheath material and plastic material of part to be formed) that are being overmoulded.

In the first embodiment of FIG. 2A-2C, instead of heating the wire by sending a current through the wire, there could be applied a high temperature to said wire from outside the mould formed by said bottom and top mould parts 101, 102.

FIG. 3 illustrates a first embodiment of a part P fixed to a heater according to the present invention. In this exemplary embodiment the heater is a cable C. The cable C comprises a wire W surrounded by a plastic sheath S. The part P is made of a plastic material which is adhered to the plastic sheath S. The plastic material of part P is preferably overmoulded around a portion of the cable C. The part P may be fixed to the cable C using e.g. the method disclosed in the embodiment of FIGS. 2A-2C. Typically the plastic material surrounds the cable over a length l_{P} which is smaller than the length of the cable l_{C}.

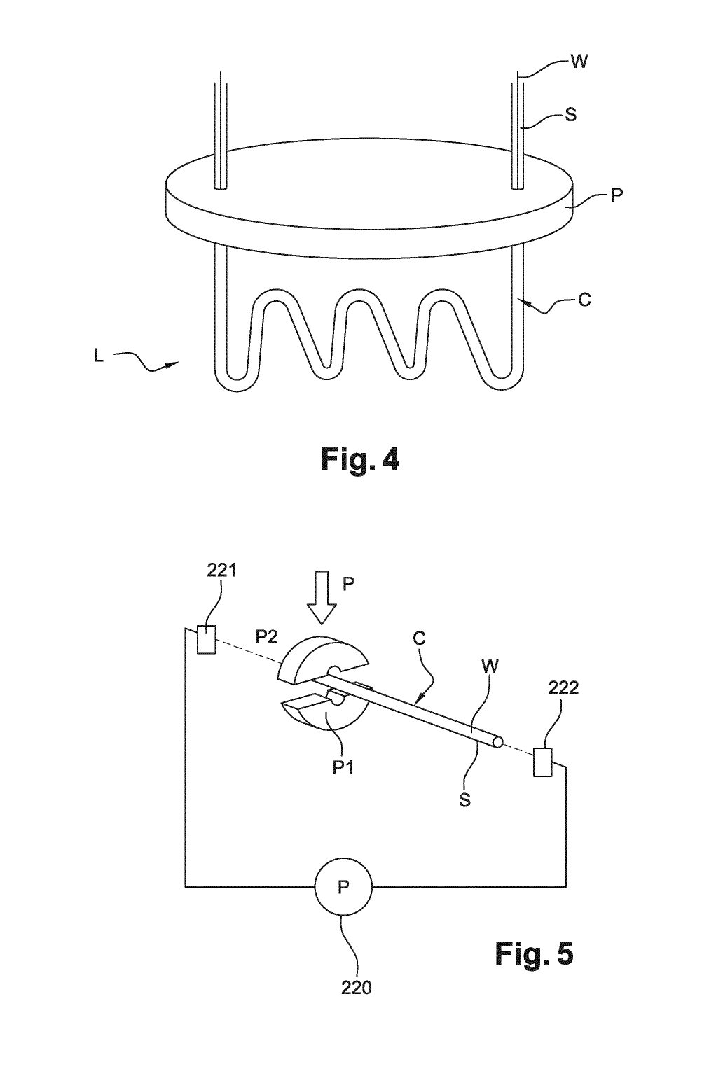

FIG. 4 illustrates a second embodiment of a part P fixed to a heater according to the present invention. In this exemplary embodiment the heater is a cable C. The cable C comprises a wire W surrounded by a plastic sheath S. The part P is made of a plastic material and is adhered at two locations to two respective circumferential portions of the plastic sheath S, such that the cable forms a loop L at one side of the part P. A possible application of such a part P, is as a flange part or a connecting part that is weldable in an opening in a urea tank, where the cable C is used as a heating element for heating a part of the tank. The plastic material of part P is preferably overmoulded around the respective portions of the cable C. The part P may be fixed to the cable C using e.g. the method disclosed in the embodiment of FIGS. 2A-2C.

FIG. 5 illustrates a second embodiment of a heater according to the present invention. In this exemplary embodiment the heater is a cable C. A plastic part is fixed to the cable C. The cable C comprises a wire surrounded by a plastic sheath S. In the illustrated embodiment the wire is an electrical wire having an electrical resistance, and the wire is heated by sending an electric current through the wire. This is done by connecting the wire via connectors 221, 222 to an electrical power source 220.

Here the applied material consists of two parts P1 and P2 of a plastic material. The applying of the plastic material comprises pressing first part P1 against second part P2 with the cable C inserted between the first part P1 and the second part P2, whilst the cable is heated such that the material of the sheath intermingles with the plastic material of the parts P1, P2 at the interface between the sheath and the parts P1, P2. If the parts P1, P2 are not too big, the heat in combination with the pressure may be sufficient to also adhere part P1 to part P2.

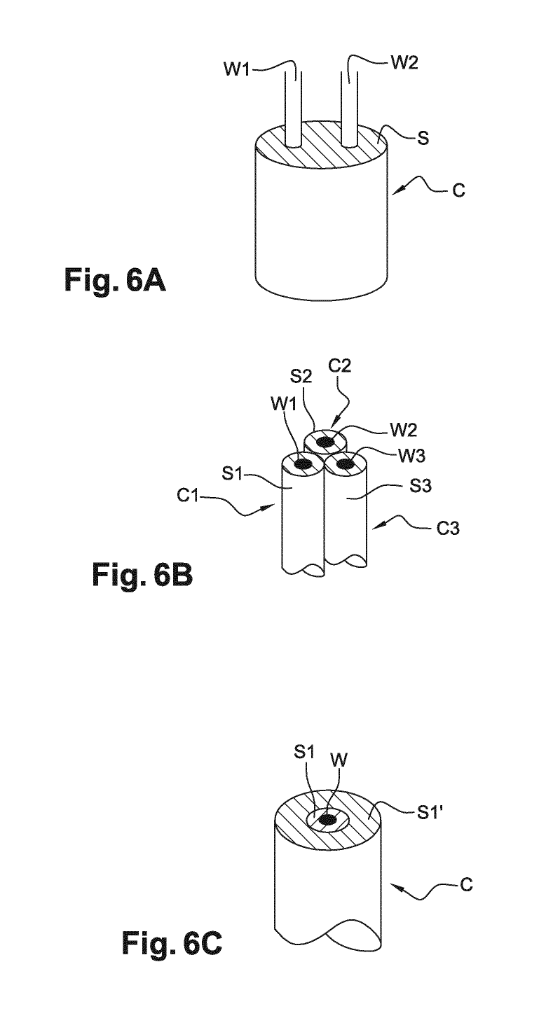

FIGS. 6A, 6B and 6C illustrate three variants of a heater according to the present invention. According to the variant of FIG. 6A the heater is a cable C. The cable C comprises a first wire W1 and a second wire W2 which are received in the same sheath S. The first wire W1 may be a highly conductive wire whilst the second wire W2 may have a determined electrical resistance so that it is capable of generating sufficient heat in the sheath when the second wire W2 is connected to a power source, e.g. the power source 120, 220 in the embodiments of FIGS. 2A-2C or of FIG. 5. The second wire W2 may have a further function, but could also have merely a heating function. The first wire W1 may be used to feed e.g. an electrical component in the tank. According to the second variant of FIG. 6B the heater is composed of a plurality of cables C1, C2, C3 which may be used in a grouped fashion. The cables may be the same or different. E.g. the electrical resistance of the wires W1, W2, W3 of the cables C1, C2, C3 may be the same or may be different. The material of the sheaths S1, S2 and S3 is the same or compatible so that a good bond may be obtained in between the cables C1, C2, and C3 on the one hand, and between the cables and the plastic material forming the part P, on the other hand.

According to the variant of FIG. 6C, the heater is a cable C. The cable C comprises a wire W surrounded by a first sheath S1 which is in turn surrounded by another sheath S1′. The material of the sheath S1 and S1′ may be different. More in particular the material of the sheath S1′ may be chosen to be compatible with the plastic material that is to be applied around the cable whilst the material of the sheath S1 may be incompatible with the plastic material applied around the cable.

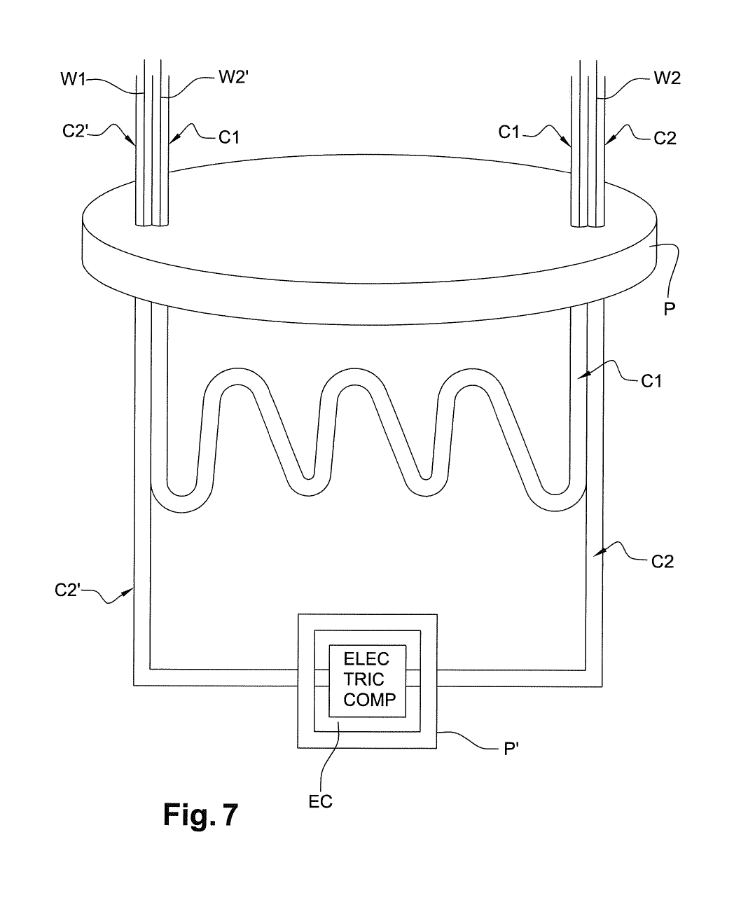

FIG. 7 illustrates a third embodiment of two parts P, P′ fixed to cables C1, C2, C2′. The first part P is fixed to cables C1, C2 and C2′, while the second part P′ is fixed to cables C2 and C2′. The first part P may be formed by overmoulding the cables C1, C2 and C2′ e.g. using the method of FIGS. 2A-2C, wherein a current is sent through cable C1 and/or C2, C2′ during the overmoulding operation. In a similar way, the second part P′ may be formed by overmoulding two cable end parts of the cables C2, C2′ which are connected to an electronic component EC. To that end the electronic component may be placed in a cavity in a mould whilst connected to the two end parts of the cables C2, C2′. Next the mould may be closed and the assembly of the electronic component and the end parts may be overmoulded with an injected plastic material whilst sending an electric current through the cables C2, C2′ such that a good bond is obtained between the sheath of the cables C2,C2′ and the injected plastic material of part P′.

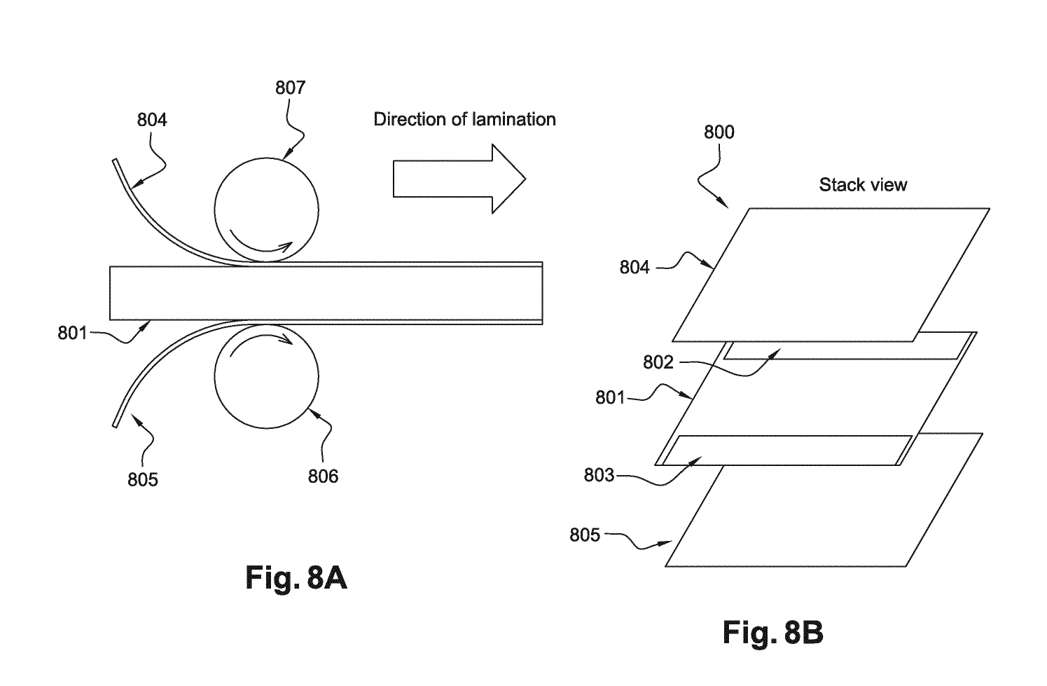

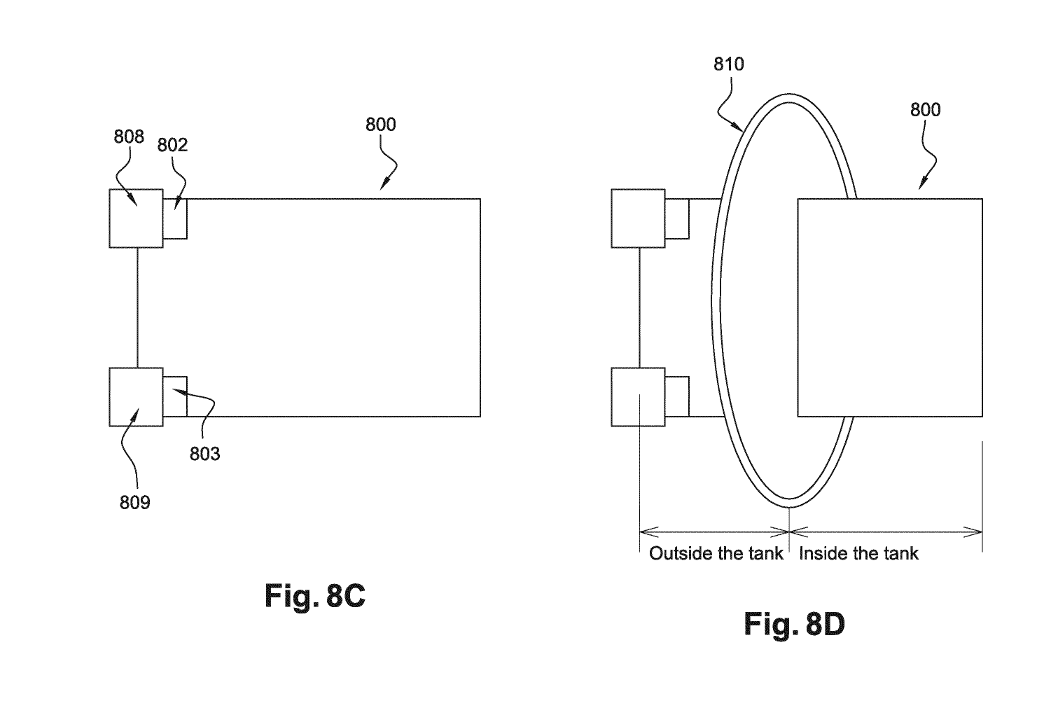

FIGS. 8A-8C illustrate another particular embodiment of a heater according to the present invention. In this another particular embodiment the heater comprises a multilayer flexible heater. The multilayer flexible heater 800 comprises an electrical heating element comprising an electrically resistive fabric 801 and two conductive tracks (802, 803) affixed to the fabric. In a preferred embodiment, the fabric 801 can comprise a polyurethane coating containing carbon particles. The coating may contaminate the urea stored in the tank. To avoid such contamination the fabric 801 may be surrounded by a thermoplastic protective film. Such thermoplastic protective film can be obtained by using a lamination process, a co-extrusion process or hot pressing process. In a preferred embodiment, the thickness of the protective film is comprises between 0,05 mm and 0,5 mm. In that way, the heater 800 remains flexible. HDPE and LDPE material are well suitable for such protective film. In general, thermoplastics may be advantageously used for such protective film as they may be further welded or overmoulded. FIG. 8A illustrates schematically an example of a lamination process. For example, the fabric 801 can have a shape of a grid. For example, the grid can have openings of about 3 mm*3 mm, which make it suitable for overmoulding by a lamination process (the overmoulded plastic can easily flow in these openings). As illustrated in the example of FIG. 8A, the electrical heating element (801, 802, 803) is sandwiched between two plastic protective films or layers (804, 805) by means of two compression rolls (806, 807). The lamination process is a continuous process. Such process is particularly suitable for high volume productions. The multilayer flexible heater 800 produced by the lamination process can then be cut at the desire length. The cutting can be performed by water jet cutting for example.

As illustrated in the example of FIG. 8C, the conductive tracks (802, 803) are equipped at one end with electrodes. These electrodes allow an electrical connection with a power supply (not represented).

As illustrated in the example of FIG. 8D, a plastic part 810 is overmoulded (i.e. hot pressing, injection molding or injection compression molding) on the multilayer flexible heater 800. In a preferred embodiment, the plastic part 810 is configured to allow the fixation of the multilayer flexible heater 800 to a flange part or to a tank wall. The fixation can be obtained by welding or overmolding. A welding path can further be integrated on the plastic part 810. The material of the plastic part 810 is chemically compatible with the protective film and with the tank wall (or the flange part). For example, HDPE or LDPE could be used. Polyethylene is easily weldable (by hot plate process for example) and formable as it has a broad processing range (from 120° C. to 280° C. short time). A leak-tight, robust interface can thus be easily obtained.

Embodiments of the method of the invention allow obtaining a sealed interface between a heater and a plastic part that is being formed e.g. by injection moulding (overmoulding), wherein polymer entanglements are achieved at the interface of the heater plastic sheath and the overmoulded plastic part. Surprisingly, it has been observed that the application of an electric current through the electrical heating element of the heater may be sufficient to increase its surface temperature to a sufficient degree so that the heater plastic sheath and the plastic material are fused together during the forming of the plastic part.

Whilst the principles of the invention have been set out above in connection with specific embodiments, it is to be understood that this description is merely made by way of example and not as a limitation of the scope of protection which is determined by the appended claims.

1-12 (canceled).

13. A heater for a plastic tank for storing urea, the heater comprising:
a part; and
an electrical heating element;
the part being fixed to the electrical heating element;
the electrical heating element being surrounded by a plastic sheath,
wherein the part comprises a plastic material which is fusion bonded to the plastic sheath, and
wherein the plastic material of the part is overmolded on the plastic sheath.

14. The heater of claim 13, wherein the electrical heating element is a resistive wire.

15. The heater of claim 13, wherein the electrical heating element comprises:
an electrically resistive fabric; and
at least one conductive track or wire affixed to the fabric.

16. The heater of claim 15, wherein the fabric comprises a polyurethane coating containing carbon particles, and wherein the el cal heating element is sandwiched between two plastic protective films, the plastic protective films forming the plastic sheath.

17. The heater of claim 13, wherein the electrical heating element and the plastic sheath are sized such that when a predetermined level of current passes through the electrical heating element, the plastic sheath is brought to a molten state to be fusion bonded to the plastic material of the part.

18. The heater of claim 13, wherein electrical resistance of the electrical heating element is larger than 0.01 Ohm/m.

19. The heater of claim 13, wherein the plastic sheath is made of a polymer material that is compatible with the plastic material of the part in that entanglements can be created at an interface of the sheath and the plastic material of the part.

20. The heater of claim 13, wherein the plastic sheath is made of a polyamide material; and/or wherein the plastic material of the part is polyethylene or a polypropylene material including an additive for increasing polarity, or a polyamide material.

21. A urea tank comprising a heater of claim 13, wherein the part is mounted in a wall part of the tank, or is a wall part of the tank, or is the tank.

22. A method for manufacturing a heater of claim 13, comprising:
selecting an electrical heating element, the electrical heating element being surrounded by a plastic sheath;
fixing a part to the electrical heating element, the part being made of a plastic material,
wherein the fixing of the part comprises:
fusion bonding the plastic material of the part to the plastic sheath and overmolding the plastic material of the part on the plastic sheath.

23. The method of claim 22, wherein the fusion bonding comprises applying a predetermined level of current through the electrical heating element to heat the electrical heating element and bringing the plastic sheath to a temperature slightly below or above a molten state.

24. The method of claim 23, wherein the overmolding comprises:
placing the electrical heating element between a first mold part including a first cavity and a second mold part including a second cavity, wherein the first and second cavity are configured to delimit a volume that surrounds the electrical heating element; and
injecting the plastic material into the volume, around the heated electrical heating element.
